(19) United States
(12) Patent Application Publication
(10) Pub. No.: US 2012/0229656 A1
(43) Pub. Date: Sep. 13, 2012

(54) DISTRIBUTED IMAGE ACQUISITION, COMMUNICATION, AND STORAGE SYSTEM

(76) Inventor: Ronald Steven Cok, Rochester, NY (US)

(21) Appl. No.: 13/042,503

(22) Filed: Mar. 8, 2011

(51) Int. Cl. H04N 5/76

(52) U.S. Cl. 348/207.1; 348/E05.001

(57) ABSTRACT

A distributed image acquisition and storage system having a communication network. Digital cameras acquire digital images and transmit the digital images through a local communication channel. Storage devices connected to the communication network receive digital images from the digital cameras through the local communication channel, store the received digital images, and transmit and receive digital images over the communication network. The system is arranged so that the storage devices stores digital images received through the separate local communication channel from associated digital cameras, transmits digital images received from non-associated digital cameras through the separate local communication network to the second storage device through the communication network, and receives and stores digital images received from associated digital cameras from the storage device through the remote communication network.

Reference is made to commonly assigned U.S. patent application Ser. No. ______ filed concurrently herewith, entitled “Distributed Image Acquisition and Storage System” by Ronald S. Cok et al, the disclosure of which is incorporated herein.

### FIELD OF THE INVENTION

The present invention relates to digital image acquisition and storage system and, in particular, to distributed storage systems.

### BACKGROUND OF THE INVENTION

Since the inception of consumer photography, over 120 years ago, numerous innovations have been developed to ease the costs and complexities of taking, viewing, and sharing photographs. The original invention of flexible roll film provided the ability to record multiple, sequential, photographs without glass plates, chemicals, and reloading cameras. This innovation combined with the simple, inexpensive, and easy to use “box camera” (U.S. Pat. No. 388,850) and centralized photo processing made picture taking more affordable and accessible. Innovations such as easy-to-load film cartridges, motorized film advance, automatic exposure, electronic flash, automatic focus, one-time use cameras, compact cameras, and zoom lenses were all directed at reducing the burden of photography. In addition, the development of integrated photo-processing equipment or “mini-labs” and “photo kiosks” made photo-processing and printing in retail environments feasible.

More recently, the development of digital cameras has provided significant benefits. Digital cameras are a common and widely used consumer electronics product, used by many people to record images and events in their lives. However, such cameras have also placed new burdens on consumer photographers. The conventional process for acquiring and managing digital images is cumbersome. Digital cameras with complex control mechanisms and modes are used to acquire images. Digital images are typically captured with an electronic sensor integrated circuit in response to a user-operated control and stored in a memory in the digital camera. After some period of time, the camera is plugged into a computer through a wired interface such as a Universal Serial Bus (USB) connector and downloaded through an interface to a computer. Wireless transfer systems employing WiFi protocols and hardware over local area networks are also known. The computer executes an image-transfer program to transfer digital images from the camera to a storage device controlled by the computer, for example rotating magnetic media such as a disk. A complex software program can then be used to manipulate, store, print, or otherwise employ the digital images. The images can be viewed, manipulated, printed, and permanently stored on the computer or with an on-line service over the Internet.

Although digital cameras eliminate the costs and complexity of film usage and processing, the user of digital photography systems must overcome a wide variety of problems. Various incompatible file formats, numerous incompatible memory card formats, image file transfer, image file storage and access, on-line image file storage, incompatible computer devices with incompatible software and interfaces, computer-centric software, and post-capture operations have all added to the complexity and costs of photography. Organization, storage, and redundant backup of personal photo collections, sometimes including many thousands of digital images and video clips, become the responsibility of the photographer. Simple photo albums, shoeboxes, and slide trays that were once the final repository of irreplaceable images were directly viewable and readily understood and used. Photographic prints, slides, and negatives are today replaced by digital-media collections. These digital-media collections are often scattered across the hard drives of several different computers, on various types of digital storage devices such as removable hard drives, optical disks, Photo CDs, CDs, DVDs, and memory cards.

On-line storage accounts provide a new method to aggregate digital media collections and assure redundant back up, but these systems require the user to periodically upload their newly acquired digital images to the on-line storage account and are subject to the rules, limitations, and fees established by the on-line storage provider. Many digital cameras require the interactive use of a computer to transfer images from the camera to a secondary storage device or system. In addition, file formats and storage devices become obsolete as new digital cameras and computers become available. All of these problems interfere with the simple pleasure of taking and using photographs. In particular, digital photography practitioners must accommodate a variety of computers and computing devices, complex, non-standard user interfaces, complex workflows, image-storage management, security challenges, and incompatible image storage formats.

The use of computer networks with a variety of connected electronic devices, including storage devices is known, for example as disclosed in U.S. Pat. No. 6,928,476 and U.S. Patent Application Publication 20050060700. U.S. Pat. No. 6,678,737 describes data management units on computer networks with associated display devices. Content management systems and networks are described in U.S. Patent Application Publication 20060026171, U.S. Patent Application Publication 20050177869, U.S. Patent Application Publication 20050125484 and in U.S. Patent Application Publication 20040162900. Systems for storing, sharing, and displaying digital images in a common collection, including images obtained from digital cameras are known, for example as taught in U.S. Pat. Nos. 7,024,051, 7,724,285 and 7,675,554. However, none of these systems provide a simple, low cost, and straightforward system or method for interacting with, managing, storing, and controlling digital images in a distributed consumer environment.

The use of WiFi wireless connectivity for communication between a camera and a computer is known. Likewise, wireless computer networks are known, as are various computer peripheral devices that interact with each other and the computer wirelessly through the computer network. Wireless data storage devices that wirelessly interact with a computer are also known. However, such networks do not overcome the challenges of prior-art digital imaging systems, particularly in a distributed system with remote locations. U.S. Pat. Nos. 7,742,084 and 7,701,490 describe transferring images from a digital camera to desired locations through a wireless network. U.S. Pat. No. 7,849,199 describes a system for routing changes to information between a plurality of content nodes such as mobile telephones and email accounts. Storage systems available on a network are also known and commercially available. Since many consumers eventually create image collections of thousands or tens of thousands of images, a large amount of storage can be needed.

Because digital cameras have limited memory sizes, acquired images must be frequently transferred to a computer. Furthermore, because a user's computer is generally at a single location although the digital cameras are mobile, it can be inconvenient to transfer images stored in a digital camera to a computer. Thus, the usefulness of the digital camera can be limited, particularly when a user is traveling.

Users are also concerned with the security of their stored digital images. Since personal images frequently have great emotional significance to users, ensuring the survival of the digital images in case of calamity, for example a hard disk crash or a household fire or flood, is important to users. Such security is typically provided with storage backup systems operated by the computer or with on-line storage. If stored on a single memory system that fails, the images can be permanently lost. To avoid such a loss, backup systems such as RAID devices and on-line storage services are available. Despite this need, typical users do not employ backup support for their personal digital images, largely because of the complexity of such systems. Managing RAID systems can be complicated and inefficient and on-line storage services can be expensive and slow, since image collections can be transferred at slow transfer rates to the on-line service. U.S. Pat. Nos. 7,764,290 and 7,271,780 address the issue of an archival storage system with an external memory system for use with an imaging system. However, further improvements and simplifications can be made, particularly for remote access.

In general, users find the interactive use of computers for receiving, storing, viewing, and using their images to be complicated, tedious, and expensive, with many barriers to access, particularly for mobile digital cameras. There is a need therefore, for an improved system and method for capturing, transferring, and storing digital images in a digital storage system.

### SUMMARY OF THE INVENTION

In accordance with the present invention, there is provided a distributed image acquisition and storage system and communication network, comprising:

a plurality of digital cameras that acquire images and transmit the digital images through a local communication channel;

a plurality of storage devices connected to the communication network that receive digital images from any of the plurality of digital cameras through the local communication channel, that store digital images, and that transmit and receive digital images over the communication network, each storage device located remotely from other storage device(s) so that each of the first and second storage devices has a separate local communication channel, and each storage device is associated with one or more of the plurality of digital cameras and not associated with other of the plurality of digital cameras; and wherein each storage device:

(a) stores digital images received from associated digital cameras;

(b) transmits digital images received from non-associated digital cameras through the communication network to the storage device that is associated with the digital camera from which the digital images are received; and

(c) receives digital images from associated digital camera(s) through the communication network from non-associated storage devices.

The present invention provides improved convenience, storage, and simplicity for users of digital image cameras. Communication between digital cameras and storage devices are enabled with security and simplicity in a highly distributed environment that provides mobility, storage, convenience, and security to digital camera users.

### BRIEF DESCRIPTION OF THE DRAWINGS

The above and other features and advantages of the present invention will become more apparent when taken in conjunction with the following description and drawings, wherein identical reference numerals have been used, where appropriate, to designate identical features that are common to the figures, and wherein:

FIG. 1A is an illustration of a digital image system including a digital camera and a storage device with a wireless local communication channel according to an embodiment of the present invention;

FIG. 1B is an illustration of a digital image system including a digital camera and a storage device with a wired local communication channel using a dock according to an embodiment of the present invention;

FIG. 2 is a front perspective, a back perspective, and a schematic of a digital camera according to an embodiment of the present invention;

FIG. 3 is a perspective and a schematic illustration of a storage device according to an embodiment of the present invention;

FIG. 4A is an illustration of a digital image system including a digital camera, a storage device, and a computer according to another embodiment of the present invention;

FIG. 4B is an illustration of a digital image system including a digital camera, a storage device, and a computer according to an alternative embodiment of the present invention;

FIG. 4C is an illustration of a digital image system including a digital camera, a storage device, and a computer according to yet another embodiment of the present invention;

FIG. 4D is an illustration of a digital image system including a digital camera, a storage device, and a computer according to another embodiment of the present invention;

FIG. 5A is an illustration of a digital image system including a digital camera, two storage devices, and a computer according to another embodiment of the present invention;

FIG. 5B is an illustration of a digital image system including two digital cameras, a storage device, and a computer according to another embodiment of the present invention;

FIG. 6 is an illustration of a stacked group of three storage devices according to another embodiment of the present invention;

FIG. 7 is a flow diagram illustrating various methods of the present invention;

FIG. 8 is a flow diagram illustrating a method of the present invention;

FIG. 9 is an illustration of a digital image system and information flow including two digital cameras, two storage devices, and a remote communication network according to an embodiment of the present invention;

FIG. 10 is an illustration of a digital image system and information flow including a digital camera, two storage devices, and a remote communication network according to an embodiment of the present invention;

FIG. 11 is an illustration of a digital image system and information flow including a digital camera, two storage devices, and a remote communication network according to an embodiment of the present invention;

FIG. 12 is an illustration of a digital image system and information flow including a digital camera, two storage devices, a server, and a remote communication network according to an embodiment of the present invention; and

FIG. 13 is a flow diagram illustrating a method of the present invention.

### DETAILED DESCRIPTION OF THE INVENTION

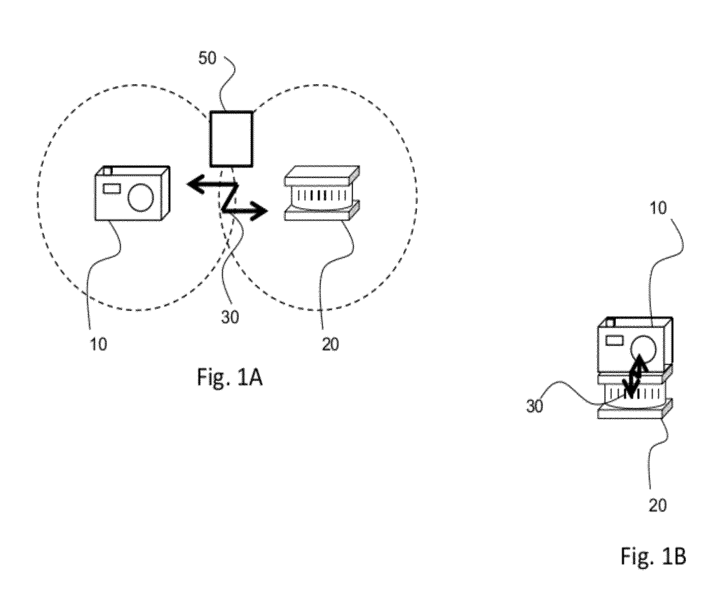

Referring to FIG. 1A, a digital image system according to an embodiment of the present invention comprises a digital camera 10 and a storage device 20 physically separate from the digital camera 10. The storage device 20 can be a non-image-display device that does not include a display for displaying information stored in the storage device 20. The digital camera 10 and the display storage device 20 interact through a local communication channel 30 to communicate information 50, for example digital images. The local communication channel 30 can be a wireless local area network (WLAN), for example a WiFi LAN or a Bluetooth point-to-point wireless connection. Alternatively, as shown in FIG. 1B, the local communication channel 30 can be a camera dock in which the dock is integrated with the storage device 20 to provide a wired, releasable electrical connection for communication and for charging. Alternatively, docks can employ an inductive connection for communication or battery charging. Camera docks are known in the art, for example Eastman Kodak sells such docks. In the Figures, the dashed circles represent electromagnetic radiation communication to or from the device within the dashed circle. Physically separate devices can be connected or disconnected with a physical connector and can require an inter-device connection to communicate. For example, two physically separate devices can be in completely different geographic locations and communicate through the internet.

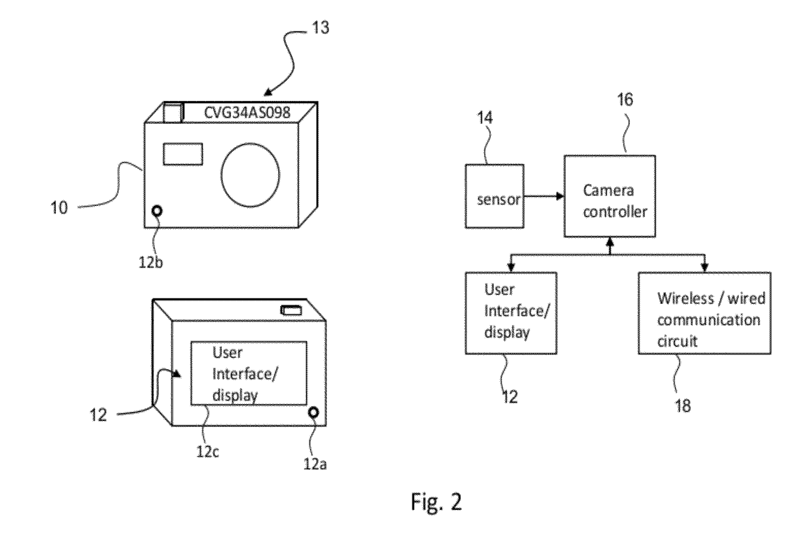

Referring further to FIG. 2, the digital camera 10 includes an image sensor 14 for acquiring digital images 50. For example, the term digital camera includes image-capture devices such as cell phones with cameras, mobile phones including image-capture devices, independent digital camera, and embedded digital cameras. The digital camera 10 includes a camera communication circuit 18, either wireless or wired, for receiving and transmitting information and digital images, a user interface 12 for interacting with a user of the digital image system, and a digital-camera controller 16 for controlling the image sensor 14, the camera wireless communication circuit 18, and the user interface 12. The user interface 12 can include an image display and control switches (not shown). In one embodiment of the present invention, the user interface 12 includes a touch screen 12c, a microphone 12b, and a speaker 12a. The digital camera 10 can include a camera identifier 13 that can be electronically stored within the digital camera 10. Image sensors 14, digital camera controller 16, wireless camera communication circuits 18, displays, switches, and touch screens employed in user interfaces 12 are all known in the electronic and computing arts. As used herein, digital images refers to still images, image sequences, video sequences, groups of images, or any multi-media element that includes images.

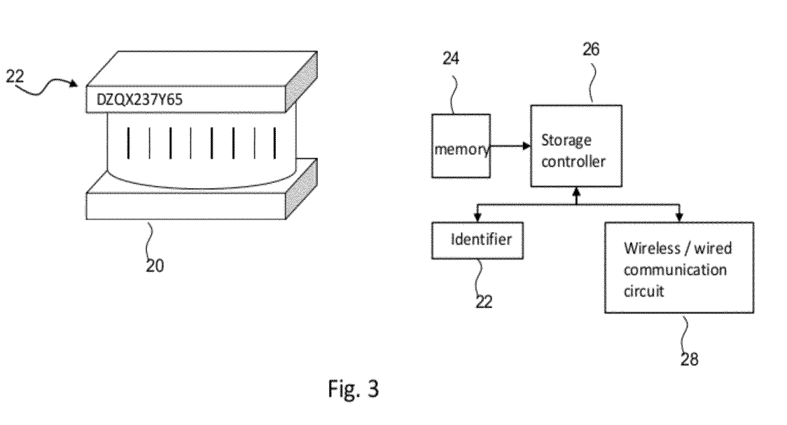

Referring to FIG. 3, the storage device 20 physically separate from the digital camera 10 includes a storage memory 24 for storing digital images, a storage identifier 22 that can be electronically stored within the storage device 20, a storage communication circuit 28 that communicates with the camera communication circuit 18 (FIG. 2), in either a wired or wireless fashion, and a storage controller 26 for controlling the storage memory 24 and the storage wireless communication circuit 28, the storage controller 26 enabling access to the storage memory 24 from a device that communicates the storage identifier 22. The storage device 20 can, but in a preferred embodiment does not, include an image-capable display. Storage controller 26, wireless communication circuits 28, memory (e.g. solid-state memories or disks) are known in the electronic and computing arts, as are values stored electronically or optically in memories.

Referring to FIGS. 1, 2, and 3 together, the digital camera controller 16 is operable to receive and store the storage identifier 22 with the user interface 12 in the digital camera 10 and to communicate the storage identifier 22 to the storage device 20 as identification to enable access to the storage memory 24. The camera communication circuit 18 is operable to transfer digital images to the storage device 20 and the communication storage circuit 28 is operable to receive digital images 50 from the digital camera 10 and store the received digital images in the storage memory 24. The camera identifier 13 and storage identifier 22 can be stored in either or both the digital camera 10 and storage device 20 and can be used to create an association between particular digital cameras 10 and storage devices 20 and to provide identification when transferring, receiving, or storing information.

The storage device 20 is separate from the digital camera 10. As intended herein, devices that are separate from one another can be physically disconnected and operated separately and remotely. The devices can communicate wirelessly within, for example, the same room, area, or building or through a wired connection, for example provided in a camera dock. When the devices are remote, they can also communicate through an extended remote computer communication network such as the internet.

If the storage device (e.g. 20) is a storage device that does not have a display capable of displaying digital images 50, a user can see a digital image 50 stored in the storage device 20 by transferring and displaying the digital image 50 to another device having an image display (e.g. digital camera 10) before, after, or during a transfer of the digital image 50 to the storage device 20. Alternatively, another device having an image-capable display can communicate with the storage device 20 and display the digital image 50 communicated from the storage device 20. According to an embodiment of the present invention, the digital camera 10 is operable to communicate with the storage device 20, transmit digital images 50 to and receive digital images 50 from the storage device 20, and display digital images 50 on the user interface 12. The storage controller 26 and the digital-camera controller 16 are operable to transfer digital images 50 from the digital camera 10 to the storage memory 24 of the storage device 20. Likewise, the storage controller 26 and the digital-camera controller 16 are operable to transfer digital images 50 from the storage memory 24 of the storage device 20 to the digital camera 10. The user interface 12 can display digital images 50 in the digital camera 10, whether acquired by the digital camera 10 or communicated from another device such as the storage device 20. Transmitted information can include a variety of information types, for example digital images 50, handshake signals, verification and security codes, device identifiers, user identifiers, network codes, web-site addresses, and internet protocol addresses.

The user interface 12 can include a wide variety of features. For example in one embodiment, the user interface 12 receives voice input and the digital-camera controller 16 recognizes information from the voice input.

According to an embodiment of the present invention, the user interface 12 is operable to control digital images 50 stored in the storage memory 24. By entering information through the user interface 12, a user can, for example, organize digital images 50, upload digital images 50, download digital images 50, and view digital images 50. Digital images 50 can be named, renamed, moved from one location to another in a file hierarchy, transmitted, duplicated, and deleted. In an embodiment of the present invention, the user interface 12 on the digital camera 10 remote from the storage device 20, can serve to control a digital-image storage software utility, e.g. a storage operating system, through the communication circuits 18, 28 and camera and storage device controllers 16, 26.

In one embodiment of the present invention, a digital-image system includes the digital camera 10 having the image sensor 14 for acquiring digital images 50, the camera communication circuit 18 for receiving and transmitting information and digital images 50, the user interface 12, and the digital-camera controller 16 for controlling the image sensor 14, the camera communication circuit 18, and the user interface 12. A storage device 20 remote from the digital camera 10 includes the storage memory 24 for storing digital images 50, the storage communication circuit 28 that communicates with the camera communication circuit 18, and the storage controller 26 for controlling the storage memory 24 and the storage communication circuit 28. The camera communication circuit 18 transfers digital images 50 to the storage device 20. The storage communication circuit 28 receives digital images 50 from the digital camera 10 and stores the received digital images 50 in the storage memory 24. The user interface 12 is operable to control digital images 50 stored in the storage memory 24.

According to various embodiments of the present invention, the camera and storage communication circuits 18, 28 are implemented in a variety of ways. In one embodiment, a point-to-point wireless interface, for example Bluetooth, is employed that enables direct, two-way communication between the storage device 20 and the digital camera 10. In an embodiment, the communication is enabled when the digital camera 10 and the storage device 20 are in proximity to each other, so that when the devices are no longer near each other, wireless communication does not occur. In another embodiment of the present invention, the camera and storage communication circuits 18, 28 implement a wireless local area network, such as a WiFi network, to provide a local communication channel and communicate information between the digital camera 10 and storage device 20. In yet another embodiment of the present invention, the camera and storage communication circuits 18, 28 implement an electrically connected interface through a docking structure associated with the storage device 20 and that physically receive the digital camera 10 to provide a local communication channel and communicate information between the digital camera 10 and storage device 20.

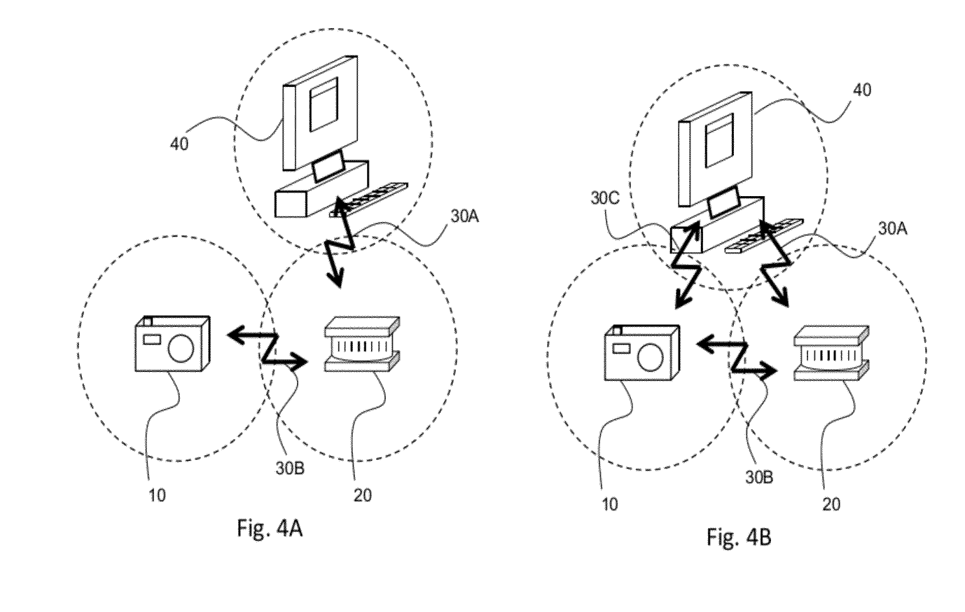

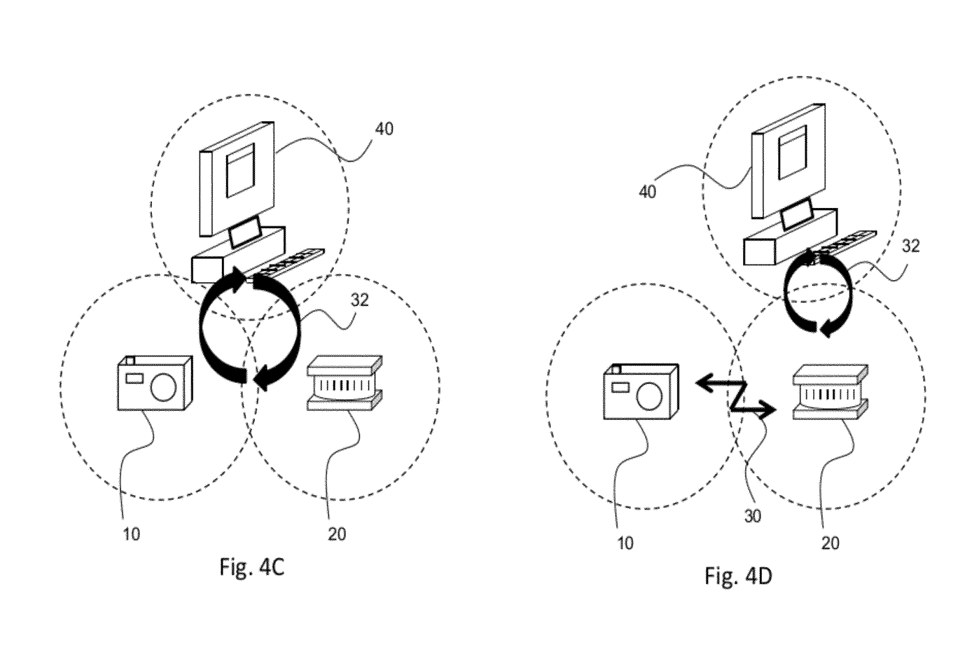

Referring to FIGS. 4A and 4B, point-to-point wireless communications between the storage device 20, the digital camera 10, and other devices can be provided. As shown in FIG. 4A, a general-purpose computer 40 is provided with a point-to-point wireless communication to the storage device 20 (but not the digital camera 10) through a wireless communication channel 30A. The storage device 20 has a separate point-to-point wireless communication to the digital camera 10 through a wireless communication channel 30B. Alternatively, as shown in FIG. 4B, the general-purpose computer 40 is provided with a point-to-point wireless communication to the storage device 20 through the wireless communication channel 30A and a separate point-to-point wireless communication to the digital camera 10 through the wireless communication channel 30C. The storage device 20 has a separate point-to-point wireless communication to the digital camera 10 through the wireless communication channel 30B.

Referring to FIG. 4C, in another embodiment of the present invention, the wireless communication forms a communication network 32 to which multiple devices can be connected. In an embodiment, the communication network 32 is controlled by the digital camera 10 or the storage device 20, or a network router (not shown) and can include a network router integrated with the digital camera 10 or the storage device 20, or can include a network router separate from the digital camera 10 or storage device 20. In this embodiment, all of the devices (digital camera 10, storage device 20, and computer 40) can communicate with each other in a single, common communication network 32. In an embodiment in which the wireless communication forms the communication network 32, both the digital camera 10 and the storage device 20 can be wirelessly connected to the same communication network 32, and other devices, for example general-purpose computers 40, can also be wirelessly connected to the communication network 32.

In an alternative embodiment of the present invention illustrated in FIG. 4D, different or additional communication structures can be employed. In one embodiment, the storage device 20 communicates with a direct, point-to-point local communication channel 30 with the digital camera 10. At the same time, in an embodiment the communication network 32 is connected to the storage device 20, for example to the general-purpose computer 40, but not to the digital camera 10. The communication network 32 connected to the storage device 20 can be a wired connection, e.g. through an Ethernet cable, or a wireless communication network, e.g. a WiFi network or a cellular network. In either of these two cases, additional devices can be connected to the communication network 32, for example routers and general-purpose computers 40. Thus, in such an embodiment, the digital camera 10 is not directly accessed by the communication network 32. In various embodiments, therefore, the local communication network 32 serves to connect the digital camera 10 to the storage device 20 and can be a direct point-to-point wired connection, a wired network, a direct point-to-point wireless connection, or a wireless network connection.

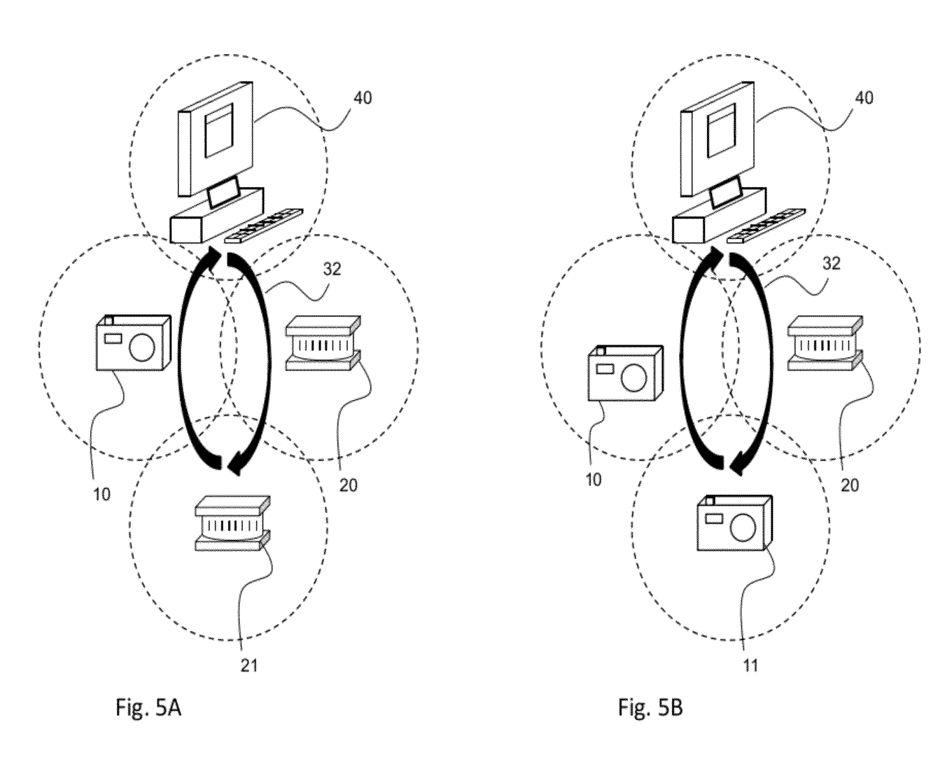

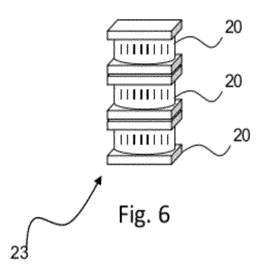

Referring to FIG. 5A, in a further embodiment of the present invention, a second storage device 21 is employed. The second storage device 21 can communicate directly with the digital camera 10 or with the storage device 20, or both. In particular, in an embodiment of the present invention, the two storage devices 20, 21 communicate with each other to provide useful digital image storage functions, for example, one storage display device (e.g. 21) can serve as a back-up to the other (e.g. 20). Alternatively, one storage device (e.g. 21) can increase the digital-image storage available to the digital camera 10. By providing suitable storage device software and intercommunication between the storage devices, a single storage system and file structure can be provided to the digital camera 10.

As noted above, a single digital camera 10 can employ multiple storage devices 20. Referring to FIG. 5B, in an alternative embodiment of the present invention, a single storage device 20 can communicate with multiple digital cameras 10. Thus, a digital system according to an embodiment of the present invention, can further include a second digital camera 11 remote from the storage device 20, the second digital camera 11 including a second image sensor for acquiring digital images 50, a second camera communication circuit for receiving and transmitting information and digital images 50, a second user interface, and a second digital-camera controller for controlling the second image sensor, the second camera communication circuit, and the second user interface. The second digital camera controller is operable to receive and store the storage identifier with the user interface in the second digital camera and to communicate the storage identifier to the storage device 20 to enable access to the image storage. The second camera communication circuit is also operable to transfer digital images to the storage device 20 and the communication storage circuit is operable to receive digital images 50 from the second digital camera 11 and store the received digital images 50 in the storage memory. In this embodiment multiple digital cameras 10, 11 employ a common storage device 20 to communicate, receive, and store digital images 50.

Referring to FIG. 6, in further embodiments of the present invention, an arbitrary number of storage devices 20 can be employed to increase the digital-image storage capacity of the digital image system. The storage devices 20 can communicate through communication networks or point-to-point communications as described above and can use either a wired or wireless communication.

If one or more storage devices 20 are accessible to a computer network, other devices on the computer network can likewise access the storage devices 20 to read, write, modify, or organize digital images. If the communication network 32 is connected to a remote communication network 34 such as the internet, storage devices 20 can be provided with internet protocol addresses and suitable web-hosting software, or accessibility software in combination with other web sites, to provide access to the storage devices 20 over the internet. Thus, digital images 50 can be controlled from external computers or can be controlled from digital cameras 10 that are connected to the internet but are not within range of a wireless connection to the storage device 20.

In further embodiments of the present invention, the storage device 20 has an associated storage identifier 22, as illustrated in FIG. 3. The use of a storage identifier 22 provides additional control to users of the digital image system. In one embodiment, only devices that provide the storage identifier 22 to the storage device 20 can control digital images to be stored, retrieved, or organized in the storage device 20. A variety of storage identifiers 22 can be employed in various embodiments of the present invention. For example, in one embodiment, the storage identifier 22 is electronic and is stored as data within the storage device 20. The storage identifier 22 can also, or in addition, be written in characters, images, or icons on a visually readable medium associated with the storage device 20. For example, in various embodiments the storage identifier is printed on a sticker affixed to the storage device 20 or printed on a sticker affixed to packaging material or documentation associated with the storage device 20. In another embodiment, the storage identifier 22 is engraved on the storage device 20 or on a plate or other medium permanently attached to the storage device 20. In yet another embodiment, the storage identifier 22 is printed on a medium that is removable from the storage device 20.

In embodiments of the present invention, the storage identifier 22 is used by the digital camera 10 to provide secure access to the storage device 20. The storage identifier 22 can be associated with the digital camera 10 in various ways. For example, in one embodiment the user interface 12 is operable to manually enter the storage identifier 22. In this case, a digital camera user interacts with the user interface 12 to enter the storage identifier 22 to the digital camera controller 16. The digital camera controller 16 can then communicate the storage identifier 22 to the storage device 20 to demonstrate to the storage device 20 that the digital camera 10 has access privileges to the storage device 20. In another embodiment, the storage identifier 22 can be communicated wirelessly from the storage device 20 to the digital camera 10. If close proximity is needed to establish wireless communication, this can be adequate to provide security to the digital camera 10 or storage device 20 user. However, in other embodiments, it can be preferred to require a manual interaction to accept the wirelessly received storage identifier 22 so that other devices that are inadvertently within wireless communication range are not inappropriately connected or confused. In this case, a user can answer a question or take a specific action with the user interface 12 to indicate the connection between the digital camera 10 and the storage device 20 (e.g. make a selection with a touch screen on a display). In one embodiment, physically docking the digital camera 10 on the storage device 20 can provide access privileges for storing transferred information. In another embodiment discussed further below, physically docking the digital camera 10 on the storage device 20 does not provide access privileges for storing transferred information.

Storage identifiers 22 can be alphanumeric sequences or strings, as shown in FIG. 3. Alternatively, storage identifiers can be images or graphic symbols such as icons. In one embodiment of the present invention, the digital camera 10 is used to take a photograph of the storage identifier 22 and the digital camera controller 16 is operable to analyze the photograph and extract the storage identifier 22. In various embodiment, the storage identifier is alphanumeric, an icon or image, or an encoded icon or image such as a one-dimensional or two-dimensional barcode.

Once communicated to the digital camera 10, the storage identifier 22 can be stored in the digital camera 10 and used thereafter to communicate with the storage device 20, for example to use the storage device 20 as a repository for digital images acquired by the digital camera 10. If the storage identifier 22 is not initially stored electronically in the storage device 20, it can be communicated to the storage device 20 and then stored. In many embodiments of the present invention, it is useful to maintain security for the digital camera 10, the storage device, 20 and any information stored in the storage device 20. Therefore, in some embodiments of the present invention, a security code can be employed. The storage identifier 22 can be employed as a security code, if it is communicated securely. In other embodiments, the security code can be supplementary. The security code can originate from the storage device 20, the digital camera 10, or be chosen by a user, for example in a fashion similar to the use of passwords. If chosen by a user, the security code can be entered through the user interface 12 by the user. As with the storage identifier 22, a security code can be an alphanumeric sequence or an image or icon, or other forms of information. In various embodiments, the security code is stored within the digital camera 10, the storage device 20, or both the digital camera 10 and the storage device 20, or is received from the storage device 20 and is stored within the digital camera 10. The security code can be entered each time a communication between the digital camera 10 and storage device 20 or can be automatically employed, once entered, for each communication, or some communications or actions can require that a security code be employed although other communications or actions do not.

In the cases in which multiple storage devices 20 or multiple cameras 10 are employed in an embodiment of a digital image system of the present invention, a common security code or the same storage identifier 22 can be employed by the multiple digital cameras 10 or storage devices 20. In one embodiment of the present invention, control access to the digital images 50 stored in the storage device 20 is provided equally from multiple digital cameras 10. In other embodiments, other digital cameras 10 can have restricted privileges with respect to the storage device 20. This latter embodiment, for example, can be useful if one digital camera 10 is operated by an adult and others are operated by children or those less skilled in managing digital-image collections.

Security codes for network access can also be provided for digital cameras 10 or for storage devices 20. According to an embodiment of the present invention, the digital image system includes a digital camera 10 having the image sensor 14 for acquiring digital images 50, the camera communication circuit 18 for receiving and transmitting information and digital images, the user interface 12, and the digital-camera controller 16 for controlling the image sensor 14, the camera communication circuit 18, and the user interface 12. The storage device 20 remote from the digital camera 10 includes the storage memory 24 for storing digital images 50, the storage identifier 22, the storage communication circuit 28 that communicates with the camera communication circuit 18, and the storage controller 26 for controlling the storage memory 24 and the storage communication circuit 28, the storage controller 26 enabling access to the storage memory 24 from a device that communicates the storage identifier 22. The digital camera user interface 12 and digital-camera controller 16 operate to provide a network access code for a wireless network to the storage device 20. The storage device 20 is responsive to the network access code to access the network.

According to an embodiment of a method of the present invention, the digital camera 10 includes the image sensor 14 for acquiring digital images 50, the camera communication circuit 18 for receiving and transmitting information and digital images 50, the user interface 12, and the digital-camera controller 16 for controlling the image sensor 14, the camera communication circuit 18, and the user interface 12 are provided. A storage device 20 remote from the digital camera 10 is provided that includes the storage memory 24 for storing digital images 50, the storage communication circuit 28 that communicates with the camera communication circuit 18, and the storage controller 26 for controlling the storage memory 24 and the storage communication circuit 28. The camera communication circuit 18 is operable to transfer digital images 50 to the storage device 20 and the storage communication circuit 28 is operable to receive digital images 50 from the digital camera 10 and store the received digital images 50 in the storage memory 24 and the user interface 12 is operable to control digital images 50 stored in the storage memory 24. In a further embodiment of the present invention, the storage device 20 is provided with the storage identifier 22. The digital camera controller 16 is operable to receive and store the storage identifier 22 with the user interface 12 in the digital camera 10 and to communicate the storage identifier 22 to the storage device 20 to enable access to the storage memory 24.

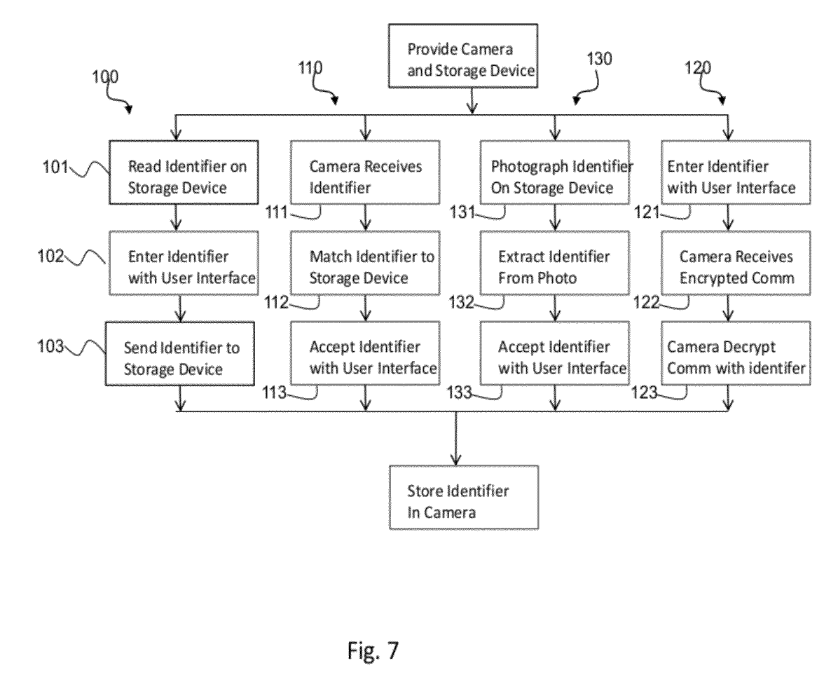

A variety of methods are employed in various embodiments to enable the present invention. Referring to FIG. 7, a variety of embodiments is illustrated. In FIG. 7, one of the paths (100, 110, 120, or 130) is used to provide and communicate the storage identifier 22. In one embodiment, illustrated as path 100, the storage device 20 is provided with the printed storage identifier 22 and read (step 101), for example on the storage device 20 or a medium associated with the device. The digital camera 10 with the user interface 12 is separately provided and the storage identifier 22 manually entered into the digital camera 10 (step 102). The wireless storage device 20 receives a communication with the storage identifier 22 to establish a secure communication (step 103). In this embodiment, the communication is preferably a wired or short-distance wireless communication so that other digital camera operators do not inappropriately communicate with the storage device 20. Once the storage device 20 has received and stored the storage identifier 22, a secure communication interface is established.

In another embodiment illustrated as path 110, the storage identifier 22 is stored in the storage device 20. The storage identifier 22 is wired or wirelessly communicated to the digital camera 10 and stored (step 111). The received storage identifier 22 can be matched to a human-readable storage identifier 22 printed on or with the storage device 20 or storage device packaging that is accessible to the appropriate digital image system user only (step 112). In one embodiment, to ensure that a digital camera user desires to interact with the storage device 20, the user is required to manually enter an acceptance into the user interface 12 to accept or acknowledge the storage device 20 and storage device interactions (step 113). Again, in this embodiment, any wireless communication is preferably a short-distance communication so that other digital camera operators do not inappropriately communicate with the storage device 20. The storage identifier 22 can also be encoded as a photograph or image (step 131) used or matched directly to provide identification or the storage identifier 22 can be extracted (step 132 e.g. by optical character recognition) from the image and accepted with the user interface 12 (step 133 in path 130). Once the storage identifier 22 is provided, it can be stored in the digital camera 10 and, if needed, in the storage device 20.

In another embodiment illustrated as path 120, the storage identifier 22 is stored in the storage device 20 and provided on a printed medium. The storage identifier 22 is entered into the digital camera 10 (step 121). The storage identifier 22 serves as a key to encrypt communications (step 122) between the storage device 20 and the digital camera 10. Since both devices have the same key, the communication is decrypted by the receiver to establish communication (step 123). Alternatively, the storage identifier 22 can be entered into the digital camera 10 before the digital camera 10 receives the encrypted communication. In yet another embodiment, after the storage identifier 22 is entered into the digital camera 10, the digital camera 10 sends an encrypted communication to the storage device 20.

To provide further security, a security code can be communicated, for example a security code selected by the user, and employed in communications between the storage device 20 and the digital camera 10. The storage identifier 22 and security code can be entered into the digital camera 10 through the user interface 12. Furthermore, communications can be encrypted, for example by using the storage identifier 22 or the security code as an encryption key. Thus, an individual that inappropriately receives wireless communications between the digital camera 10 and the storage device 20 is not able to understand the communication. In one example of the present invention, the storage identifier 22 is stored in the storage device 20, provided on or with the storage device 20 in human-readable form, and then separately entered into the digital camera 10. The storage device 20 and the digital camera 10 then communicate with an encrypted communication that is encrypted using the storage identifier 22 as a key. Since both the digital camera 10 and the storage device 20 use a common encryption key, they can decrypt the communication and communicate. Any other device that intercepts the communication cannot decrypt the communication. Unless unauthorized access is obtained to the human-readable storage identifier 22 associated with the storage device 20, this method will provide a secure interaction and connection between the digital camera 10 and the storage device 20.

In another embodiment of the present invention, a second storage device 20 is added to the digital image system. In this embodiment, the initial communications between the digital camera 10 and the second storage device 20 are the same, except that a different storage identifier 22 is employed. In various embodiments, the digital camera user interface 12 and digital camera controller 16 can operate to communicate to both or either of the storage devices 20 and the storage devices 20 can directly intercommunicate, as controlled through the digital camera user interface 12. Thus, one storage device 20 can act as an extended memory or a backup to the other.

In yet another embodiment of the present invention, a second digital camera 10 is added to the digital image system. In this embodiment, the initial communications between the second digital camera 10 and the storage device 20 are the same. The storage device 20 can communicate with both digital cameras 10, either separately or at the same time. In one embodiment, one digital camera 10 is controlled to have limited access rights to the storage device 20. In another embodiment, the two digital cameras 10 communicate directly.

The digital camera 10 and storage device 20 can communicate directly. In another method of the present invention, a remote communications network 34 is included in the digital image system. The remote communications network 34 can be accessed by the storage device 20, by the digital camera 10, or by both the digital camera 10 and the storage device 20. The remote communications network 34 can be provided only to the storage device 10 and can communicate with a wireless, wired, or cellular connection. According to a further method of the present invention, the remote communications network 34 can be connected to the internet or be the internet and the storage device 20 is accessed through the internet to control the digital images 50 stored on the storage device 20. In this case, access can be restricted to communications that employ the storage identifier or the security code or both. Because wireless networks can, in some circumstances, have limited communications capability, according to a method of the present invention, the digital camera 10 first communicates a low-resolution version of a digital image 50 and subsequently communicates a high-resolution version of the digital image 50. This can also be useful for other communication methods when bandwidth or time is limited.

In one method of the present invention, the digital camera 10 and the storage device 20 are purchased. The digital camera 10 is purchased with the storage device 20, and both the digital camera 10 and the storage device 20 electronically store the same storage identifier 22 or related identifiers. Both the digital camera 10 and the storage device 20 are operable to encrypt and decrypt wireless communications with the storage identifier 22. The digital camera 10 and user interface 12 are operable to provide additional instructions to the digital system to organize the storage device storage 20 as desired, for example for single or multiple users.

Thereafter, when the digital camera 10 and the storage device 20 are in proximity or connected to a common wired or wireless network, the digital camera 10 can interact with the storage device 20 using secure communications to store and retrieve information such as digital images 50. If a common network is used, the user interface 12 on the digital camera 10 can be employed to provide access codes to the network for the digital camera 10, the storage device 20, both the digital camera 10 and the storage device 20, or only one of the digital camera 10 and storage device 20. The storage device 20 can be connected to the communications network 32 although the digital camera 10 is not, or the digital camera 10 can be connected to the communications network 32 although the storage device 20 is not.

In another method of the present invention, the digital camera 10 and the storage device 20 are purchased separately. The storage device 20 electronically stores the storage identifier 22 and includes packaging material with the storage identifier 22 provided. The digital camera user interface 12 is operated to enter the identifier into the digital camera 10. Both the digital camera 10 and the storage device 20 are operable to encrypt and decrypt communications with the storage identifier 22. The digital camera 10 interacts with the storage device 20 using the storage identifier 22 to establish a connection between the digital camera 10 and the storage device 20. The digital camera 10 and user interface 12 are operable to provide additional instructions to the digital system to organize the storage device 20 storage as desired, for example for single or multiple users. Thereafter, communications between the storage device 20 and the digital camera 10 can proceed as described above. Network access can be provided as described above.

If additional digital cameras 10 are desired to operate with the same storage device 20, the same process can be followed as described above, using the storage identifier 22. If an additional storage device 20 is desired, the additional storage identifier 22 can be provided to the digital camera 10 and communications established between the digital camera 10 and the additional storage device 20. In one embodiment of the present invention, the digital camera controller 16 and the two storage controllers 26 interoperate to organize the storage in the two storage devices 20 as a unified storage system, as desired, for example as backup, as a single extended storage space, to manage storage for multiple users, or to manage storage for multiple cameras. The storage space can also be organized to provide separate storage for each of multiple users. Each user can have a single logical storage space that can be distributed across multiple storage devices 20.

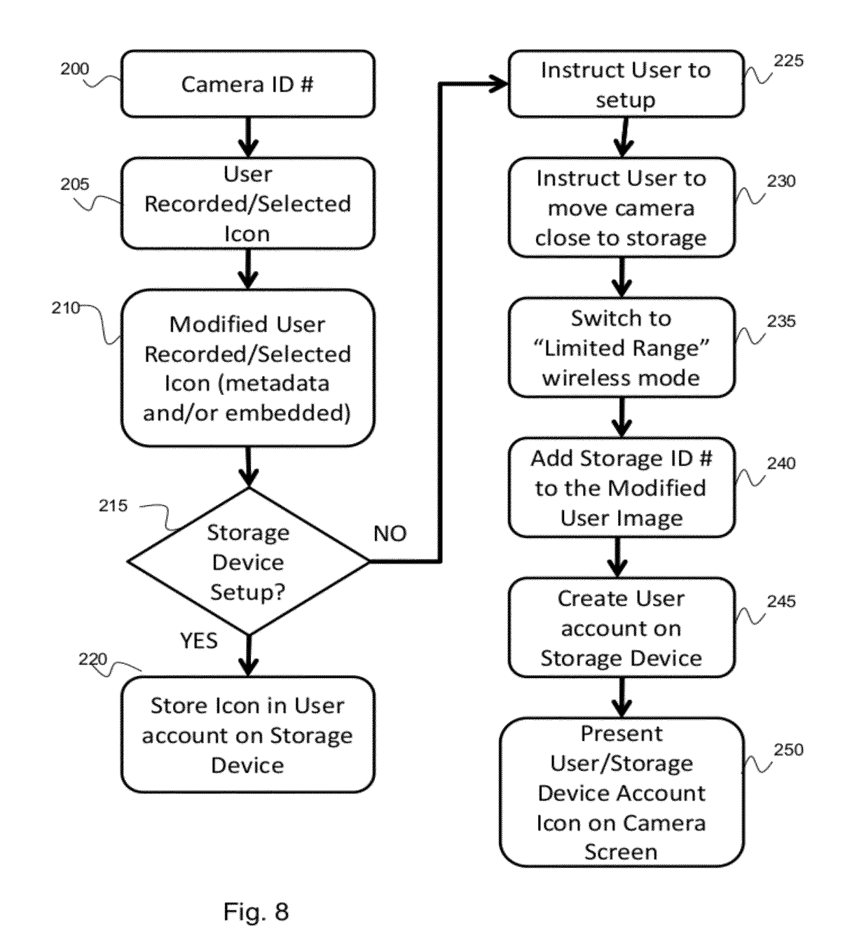

Referring to FIG. 8, in another example of one embodiment of the present invention, a graphic symbol or image is used as the storage identifier 22. FIG. 8 illustrates a process of selecting and assigning the storage identifier 22 to the digital camera 10 and storage device 20 system. In step 200, the digital camera identification is assigned. This assignment can be made at production or can be a storage identifier 22 provided by a user, for example through the user interface 12. In step 205, an image, graphic symbol, or icon is taken, made, or selected. For clarity in this example, the image, graphic symbol, or icon will be referred to as an icon. In step 210, the icon is modified or processed to be a suitable size and to include any useful characteristic required by the digital camera 10 or storage device 20, for example file size and format. Metadata can also be associated with the icon and stored with it, for example in the header of an image file or embedded in the image. The status of the storage device 20 is checked in step 215. If the storage device 20 is already properly associated with the desired camera 10 and user and the desired storage structures are organized, the icon can be transmitted to the storage device 20 and stored in the storage device 20 and associated with the user. Thereafter, when the digital camera 10 interacts with the storage device 20, by communicating the icon and comparing the communicated icon with the locally stored icon, the digital camera 10 and storage device 20 can verify the identification of the communicator to provide security in storage and communications.

If the storage device is not yet organized, for example the first time the devices are started, the user can be instructed to set up the system in step 225, for example by providing a message to the user through the user interface 12. The user is instructed to move the digital camera 10 close to the storage device 20, for example to enable a proximity point-to-point communication or to enable wireless network access by the digital camera 10 in step 230. The user can be requested to enter any network codes, if needed. In a point-to-point proximity communication, such network codes are not needed. In step 235, the user is requested to set any appropriate switches in the digital camera 10 to enable communication with the storage device 20. The storage identifier 22 identifying the storage device 20, for example an alphanumeric code is associated with the icon in step 240, and communicated to the storage device 20. The storage device 20 stores the icon and organizes the storage to match the digital camera 10 request, for example by providing a user account, in step 245. In step 250, the information is presented to the user on the user interface 12 as a confirmation.

Digital cameras 10 are typically used as mobile devices to acquire images at various different locations. Although storage devices 20 are not necessarily similarly mobile, according to an embodiment of the present invention, storage devices 20 can be similarly mobile. In this embodiment, for example, a user can travel with both the digital camera 10 and the storage device 20 and periodically connect the digital camera 10 through a local communication connection (e.g. a docking procedure) to transfer digital images 50 from the digital camera 10 to the storage device 20.

In another embodiment, the digital camera 10 is mobile although the storage devices 20 are not necessarily mobile and are kept, for example at a user's home. In this situation, it is useful to be able to transfer digital images 50 acquired by the digital camera 10 to a remote storage device 20. According to an embodiment of the present invention, this can be accomplished by enabling a digital camera 10 to communicate through the local communication channel 30 to any storage device 20 that is connected to the remote communication network 34, even if the storage device 20 and the digital camera 10 are not associated with each other. By remote communication network 34 it is meant a communication network that is connected to two or more storage devices 20 and for which at least one of the storage devices 20 cannot be communicated with through a local communication channel 30, for example because it is not physically accessible or two far away (out of range). For example, a remote communication network 34 such as the internet can interconnect two separate and different storage devices 20 in two different locations. Remotely connected storage devices 20 have separate local communication channels 30 that are not shared with a digital camera 10. Thus, the digital camera 10 that communicates through the local communication channel 30 with one storage device 20 cannot communicate through the same local communication channel 30 with another storage device 20 that is remotely connected through the remote communication network 34.

In this embodiment, each digital camera 10 has one or more associated storage devices 20 and one or more storage devices 20 that are not associated. The digital camera 10 can communicate locally to any storage device 20 with which it is associated, as described above. Additionally, the digital camera 10 can communicate locally with any storage device 20 with which it is not associated, for example by docking the digital camera 10 with the storage device 20. When the digital camera 10 communicates locally with a non-associated storage device 20, information is transferred from the digital camera 10 to the non-associated storage device 20. However, security permissions can be different than for communication between associated devices, for example preventing editing, viewing, or managing images stored in the local non-associated storage device 20. The non-associated storage device 20 then forwards the received information to the storage device 20 associated with the digital camera 10 through the remote communication network 34. The associated storage device 10 receives the information through the remote communication network 34 and stores the received information.

The storage devices 20 are functionally identical so that any storage device 20 can receive information from any digital camera 10. By functionally identical is meant that each storage device 20 can communicate with each digital camera 10 and forward information to any storage device 20, as needed. Functionally identical storage devices 20 can differ, for example by the amount of storage or speed of interaction or transmission, and by identification.

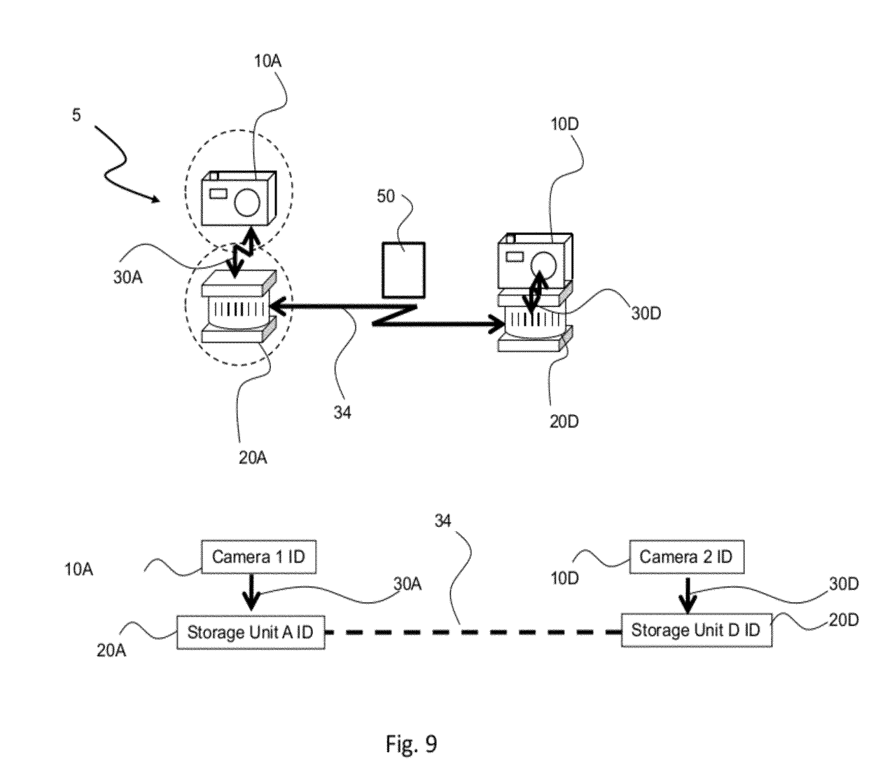

Referring to the examples of FIGS. 9, 10, 11, and 12, a digital camera 10A is associated with a storage device 20A and includes a local communication channel 30A. A digital camera 10D is associated with a storage device 20D and includes a local communication channel 30D. Storage devices 20A and 20D are connected through the remote communication network 34, for example the internet.

Thus according to an embodiment of the present invention and as illustrated in FIG. 9, a distributed image acquisition and storage system 5 includes the remote communication network 34, first and second digital cameras 10A, 10D that acquire digital images 50 and transmit the digital images 50 through the local communication channel 30A, 30D, first and second identical storage devices 20A, 20D connected to the remote communication network 34 and that receive digital images 50 from the first and second digital cameras 10A, 10D respectively through the local communication channels 30A, 30D, to store the received digital images 50, and to transmit and receive digital images 50 over the remote communication network 34. The remote communication network 34 connects devices that are spatially or geographically remote or distant from each other, for example separated by many kilometers, in contrast to the local communication channel that requires connected communicating devices to be relatively nearby, for example within a local area network, a point-to-point wireless communication network, or directly electrically connected with a connector. Because the second storage device 20D is remote from the first storage device 20A, each of the first and second storage devices 20A, 20D has a separate local communication channel 30A, 30D. The storage devices 20A, 20D can be functionally identical. Each of the first and second digital cameras 10A, 10D only transmits and receives digital images 50 directly through the separate local communication channel 30D, 30A with one of the first and second storage devices 20A, 20B at one time. The digital cameras 10A, 10D can communicate with their associated storage devices 20A, 20D respectively, at the same time.

As shown in FIG. 9, the first storage device 20A stores digital images 50 received through the separate local communication 30A channel from the first digital camera 10A. The second storage device 20D stores digital images 50 received through the separate local communication 30D channel from the second digital camera 10D.

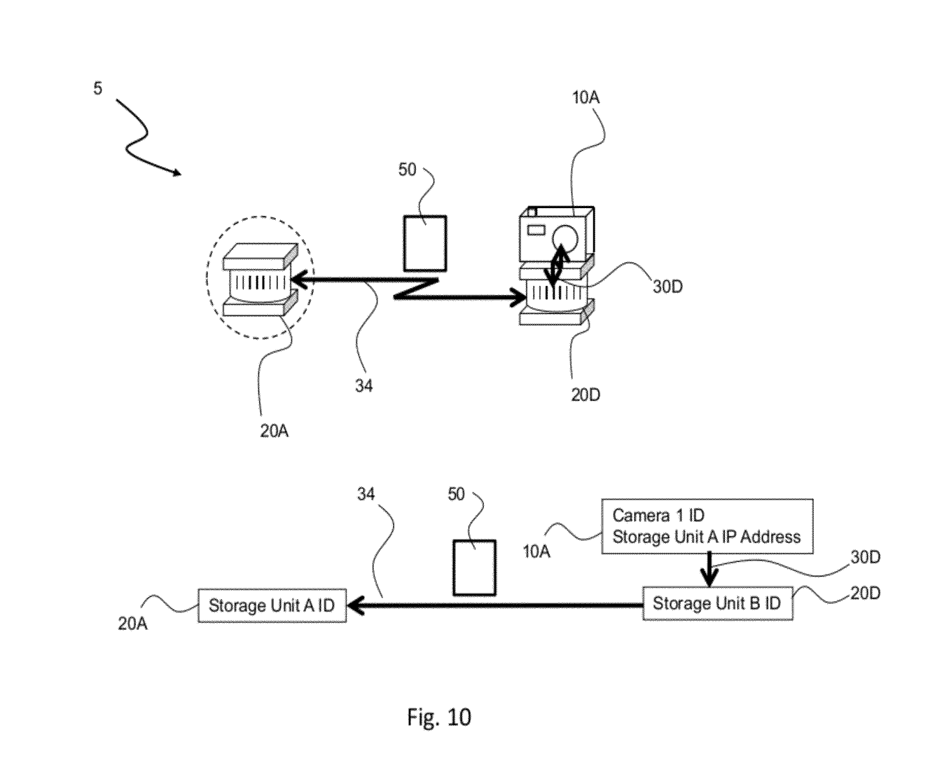

As shown in FIG. 10, the second storage device 20D also transmits digital images 50 received from the first digital camera 10A through the separate local communication network 30D to the first storage device 20A through the remote communication network 34 and the first storage device 20A receives and stores digital images 50 received from the second storage device 20D through the remote communication network 34.

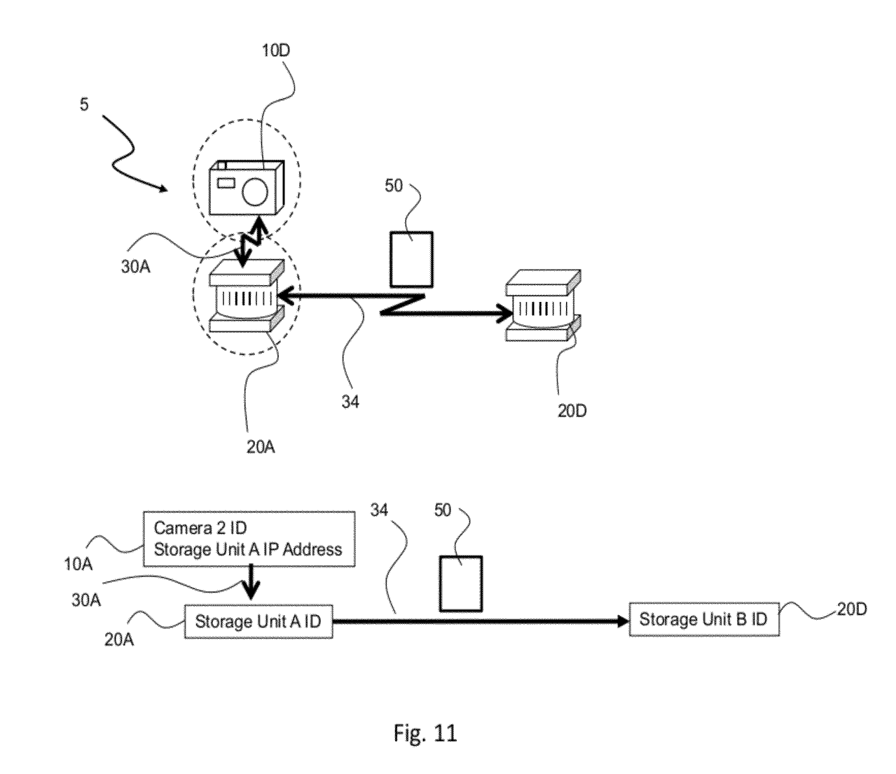

Similarly, as shown in FIG. 11, the first storage device 20A also transmits digital images received from the second digital camera 10D through the separate local communication network 30A to the second storage device 10D through the remote communication network 34 and the second storage device 20D receives and stores digital images 50 received from the first storage device 20A through the remote communication network 34.

As is also shown in FIG. 9, digital camera 10A is directly and wirelessly connected to storage device 20A and can transmit and store acquired digital images 50 in storage device 20A by communicating a camera identifier 13 that is stored and matched in the storage device 20A to enable storing acquired digital images 50 from digital camera 10A in storage device 20A. Similarly, digital camera 10D is directly wired and connected to storage device 20D and can transmit and store acquired digital images 50 in storage device 20D by communicating the camera identifier 13 that is stored and matched in the storage device 20D to enable storing acquired digital images 50 from digital camera 10D in storage device 20D. In this case, each digital camera 10A and 10D is directly connected to the storage device 20A, 20D with which it is associated.

In the examples of FIG. 10, the digital cameras 10A, 10D are not directly connected to their associated storage devices 20A, 20D. Digital camera 10A is directly wired and connected to storage device 20D. Therefore, to enable storage device 20D to forward digital images received from digital camera 10A, digital camera 10A provides both digital camera identification and the network location (address) of the associated storage device 20A. The storage device 20D receives the camera identification for digital camera 10A and the network location of storage device 20A, and forwards the camera identifier 13 and any digital images 50 to the storage device 20A. The storage device 20A receives the camera identifier 13 and validates it as belonging to an associated digital camera 10A, 10D, and then receives the digital images 50 and stores them. The digital camera 10A can find the network location of the storage device 20A during an initial setup or direct local communication between the digital camera 10A and the storage device 20A, as illustrated in FIG. 9.

Similarly, as shown in FIG. 11, the digital cameras 10A, 10B are not directly connected to their associated storage devices 20A, 20D. Digital camera 10D is directly and wirelessly connected to storage device 20A. Therefore, to enable storage device 20A to forward digital images 50 received from digital camera 10D, digital camera 10D provides both a camera identifier 13 and the network location (address) of the associated storage device 20D. The storage device 20A receives the camera identifier 13 for digital camera 10D and the network location of storage device 20D, and forwards the camera identifier 13 and any digital images 50 to the storage device 20D. The storage device 20D receives the camera identifier 13 and validates it as belonging to an associated digital camera 10A, 10D, and then receives the digital images 50 and stores them. The digital camera 10D can find the network location of the storage device 20D during an initial setup or direct local communication between the digital camera 10D and the storage device 20D, as illustrated in FIG. 9.

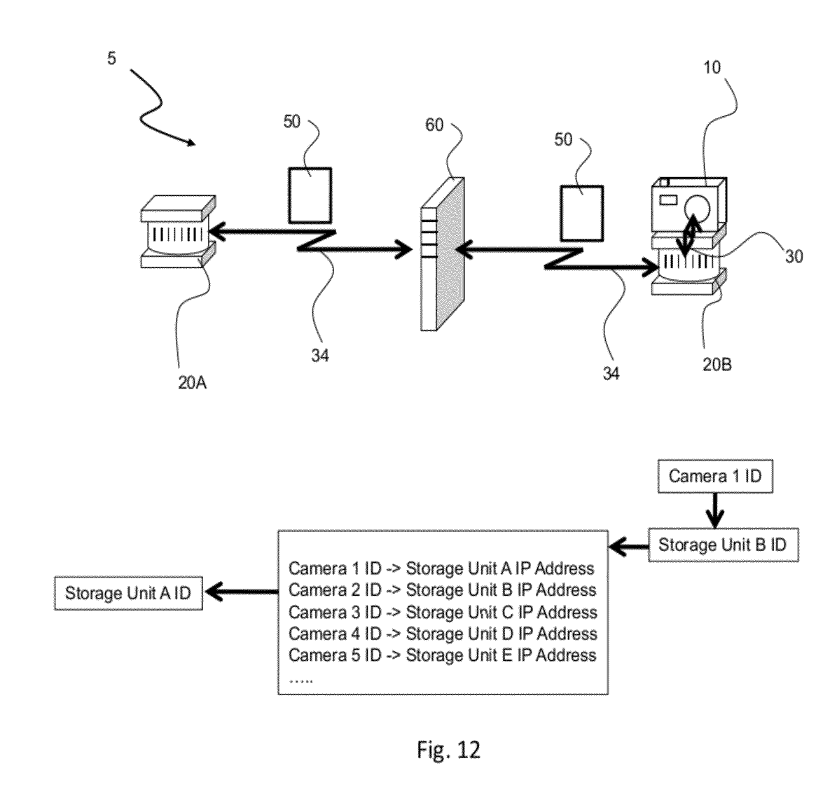

In the examples of FIGS. 10 and 11, each digital camera 10A, 10D must maintain a network location for any associated storage devices 20A, 20D. Alternatively, as shown in FIG. 12, an intermediate computer server 60 can be employed to discover the network location (address) for a given digital camera 10A, 10D. In this case, when the digital camera 10A is first associated with the storage device 20A, the storage device 20A can report the association to a third-party computer server 60, for example on the internet. The third-party computer server 60 can have a fixed communication network address. When a storage device 20B receives the camera identifier 13 from a non-associated digital camera 10A, the storage device 20B can communicate the camera identification to the third-party computer server 60 and obtain in return the network location address of the storage device 20A associated with the locally communicating digital camera 10A. Any information received from the digital camera 10A can then be forwarded directly to the storage device 20A at the network location provided by the computer server 60. Alternatively, the camera identifier 13 and information received by the storage device 20B can be forwarded to the third-party computer server 60, which can then forward the information to the storage device 20A associated with the identified digital camera 10A.

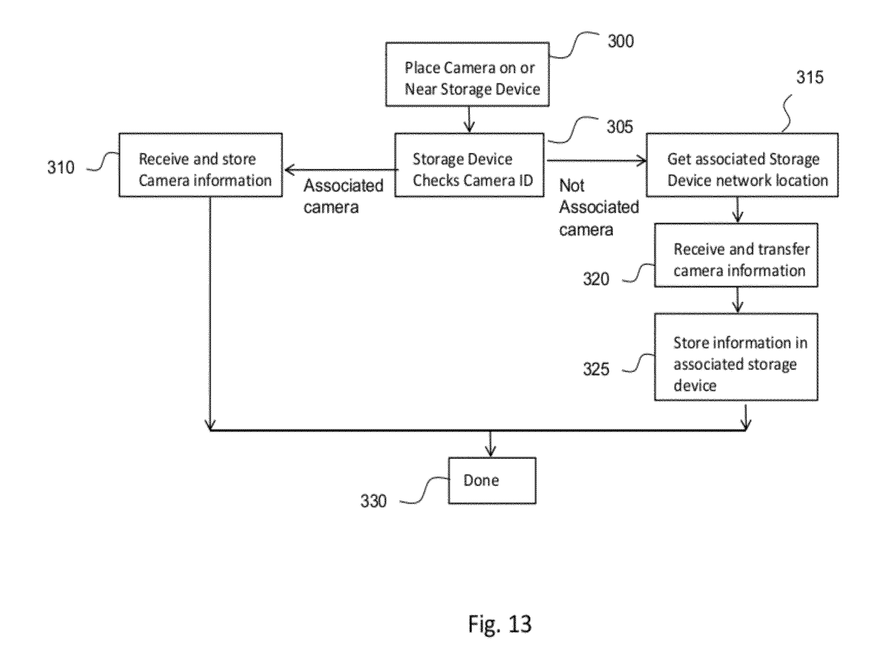

According to an embodiment of the present invention and as illustrated in the flow diagram of FIG. 13, a user can dock (or place within wireless communication range, depending on the system) the digital camera 10A, 10D on the storage device 20A, 20D in step 300. The storage device 20A, 20D checks the camera identifier 13 to determine whether it is associated with the digital camera 10A, 10D in step 305. If the digital camera 10A, 10D is associated with the storage device 20A, 20D, the storage device 20A, 20D receives the information from the digital camera 10A, 10D in step 310. If the digital camera 10A, 10D is not associated with the storage device 20A, 20D and is remote from the storage device 20A, 20D with which the digital camera 10A, 10D is associated, the storage device 20A, 20D obtains the associated storage device 20A, 20D network location, in step 315. This can be done either by receiving it from the digital camera 10A, 10D (as illustrated in FIGS. 10, 11) or from a mediating server to which the storage device 20A, 20D supplies the camera identifier 13 (as in FIG. 12). Once the network location is determined, the storage device 20A, 20D can receive and transfer digital images 50 to the storage device 20A, 20D associated with the digital camera 10A, 10D (step 320) that receives and stores the information (step 325). The process is then complete (step 330).

In various embodiments of the present invention, the remote communication network 34 can be the internet, the local communication channel is a wireless local area network, or the local communication channel 30, 30A, 30B, 30C is a dock interface between a storage device 20, 20A, 20D and a digital camera 10, 10A, 10D. The system can include a plurality of functionally identical storage devices 20, 20A, 20D, each having a unique communication network address identifier, for example an internet protocol address or universal resource locator or universal resource indicator. Each storage device 20, 20A, 20D can be associated with one or more digital cameras 10, 10A, 10D. Multiple storage devices 20, 20A, 20D can be associated with a single digital camera 10, 10A, 10D, for example to expand the available storage space or to provide backup for stored information. Each of the digital cameras 10, 10A, 10D can include a unique communication network address identifier, a storage device 20, 20A and 20D and can transmit the unique communication network address identifier with the digital images 50 to the storage device 20, 20A, 20D. The functionally identical storage devices 20, 20A, 20D can receive and store digital images 50 from digital cameras 10, 10A, 10D with which the storage device 20, 20A, 20D is associated and can receive and transfer or forward digital images 50 from digital cameras 10, 10A, 10D with which the storage device 20, 20A, 20D is not associated.

The computer server 60 can be connected to the remote communication network 34 to receive digital images 50 from storage devices 20, 20A, 20D and to transmit the received digital images 50 to other storage devices 20, 20A, 20D. The computer server 60 can maintain a list of associations between digital cameras 10, 10A, 10D and storage devices 20, 20A, 20D, and a network location address for the associated storage devices 20, 20a, 20D. The network location addresses can be supplied in response to storage devices 20, 20A, 20D providing camera identification information. Hence, the distributed image acquisition and storage system of an embodiment of the present invention can include a first identifier and first address associated with the first storage device 20A and a second identifier and second address different from the first identifier and first address associated with a second storage device 20D. The first digital camera 10A can transmit the first identifier with the transmitted digital images 50 and the second digital camera 10D can transmit the second identifier with the transmitted digital images 50. The computer server 60 includes an association list 52 having the first identifier associated with the first address and the second identifier associated with the second address. The computer server 60 can receive one or more first digital images 50 with the first identifier and transmit the first digital images 50 to the first storage device 20A at the first address and can receive one or more second digital images 50 with the second identifier and transmit the second digital images 50 to the second storage device 20D at the second address.

The storage devices 20A, 20D can be configured to each provide a separate and distinct single logical storage structure. Alternatively, groups of storage devices 20A, 20D together can provide a separate and distinct single logical storage structure.

In a further embodiment of the present invention, a distributed image acquisition and storage system and communication network includes a plurality of digital cameras 10, 10A, 10D that acquire digital images 50 and transmit the digital images 50 through a local communication channel 30, 30A, 30B, 30C, 30D; a plurality of functionally identical storage devices 20, 20A, 20D connected to the communication network 32 and that receive digital images 50 from any of the plurality of digital cameras 10, 10A, 10D, through the local communication channel 30, 30A, 30B, 30C, 30D, that store digital images 50, and that transmit and receive digital images 50 over the communication network 32, each storage device 20, 20A, 20D located remotely from other storage device(s) 20, 20A, 20D so that each of the first and second storage devices 20A, 20D has a separate local communication channel 30, 30A, 30B, 30C, 30D, and each storage device 20, 20A, 20D is associated with one or more of the plurality of digital cameras 10, 10A, 10D and not associated with other of the plurality of digital cameras 10, 10A, 10D; and wherein each storage device 20, 20A, 20D stores digital images 50 received from associated digital cameras 10, 10A, 10D; transmits digital images 50 received from not-associated digital cameras 10, 10A, 10D through the communication network 32 to the storage device 20, 20A, 20D that is associated with the digital camera 10, 10A, 10D from which the digital images 50 are received; and receives digital images 50 from associated digital camera(s) 10, 10A, 10D through the communication network 32 from non-associated storage devices 20, 20A, 20D. Each of the storage devices 20, 20A, 20D can provide a separate and distinct single logical storage structure.

The present invention provides a method of distributing and storing acquired digital images 50, including providing a distributed image acquisition and storage system as described above, providing an address for each storage device 20, 20A, 20D and including in each digital camera the address for the storage device 20, 20A, 20D associated with the camera, acquiring a digital image with a digital camera 10, 10A, 10D, transmitting the digital image 50 and associated storage device address from the digital camera 10, 10A, 10D to a non-associated storage device 20, 20A, 20D, transmitting the digital image 50 from the non-associated storage device 20, 20A, 20D through the communication network to the storage device 20, 20A, 20D associated with the digital camera 10, 10A, 10D, and storing the digital image 50 in the storage device 20, 20A, 20D associated with the digital camera 10, 10A, 10D.

The present invention also includes a method of distributing and storing acquired digital images includes providing a distributed image acquisition and storage system as described above, providing an address and an identifier for each storage device 20, 20A, 20D and including in each digital camera 10, 10A, 10D the identifier for the storage device 20, 20A, 20D associated with the digital camera 10, 10A, 10D, providing the computer server 60 connected to the communication network 32, the computer server 60 having an association list 52 including an association between the identifiers and the address for each storage device 20, 20A, 20D, acquiring a digital image 50 with the digital camera 10, 10A, 10D, transmitting the digital image 50 and associated storage device 20, 20A, 20D identifier from the digital camera 10, 10A, 10D to a non-associated storage device 20, 20A, 20D, transmitting the digital image 50 and associated storage device 20, 20A, 20D identifier from the non-associated storage device 20, 20A, 20D through the communication network 32 to the computer server 60, determining the address of the associated storage device 20, 20A, 20D with the received associated storage device identifier by employing the association list 52 on the computer server 60, transmitting the digital image 50 from the computer server 60 through the communication network 32 to the storage device 20, 20A, 20D associated with the digital camera 10, 10A, 10D, and storing the digital image 50 in the storage device 20, 20A, 20D, associated with the digital camera 10, 10A, 10D.

According to various embodiments of the present invention, a single logical storage structure can be separately provided for each identified user of the digital image system, for example for multiple users of a single digital camera. Alternatively, a single logical storage structure can be organized for individual cameras. In yet another alternative, a single logical storage structure is shared between multiple users or multiple cameras.

Storage devices are known in the art, as are wireless circuits and communication methods. Digital computing circuits and computers are known and software to manage the transfer and organization of digital images on one or multiple devices are known. Digital cameras are also commercially available. These tools can be used to implement the digital image system of the present invention.

The various embodiments of the present invention provide a simplified interface for digital imaging practitioners. By employing a direct, local communication interface, communication between a digital camera and storage device is simplified and removes the need for intermediate computers for managing the reception and storage of digital images. Indeed, once the system is set up, the user need do nothing but bring the digital camera into proximity with the storage device to download and store images (for a wireless local communication). Moreover, image review of stored images can be done on the digital camera display, rather than requiring a digital computer, reducing costs for users. If remote access through a computer network is desired, simple browsing devices such as net-books or tablet computers can be employed.

Furthermore, by enabling storage-devices access through a computer network with functionally similar storage devices, digital images can be transferred from a digital camera to the storage device through a communication network such as the internet without any intervention by the user.

The invention has been described in detail with particular reference to certain preferred embodiments thereof, but it will be understood that variations and modifications can be effected within the spirit and scope of the invention.

### PARTS LIST

5 distributed image acquisition and storage distribution system
10, 10A, 10B digital camera
11 second digital camera
12 user interface
12a speaker
12b microphone
12c touchscreen
13 camera identifier
14 image sensor
16 digital-camera controller
18 camera communication circuit
20, 20A, 20B, 20D storage device
21 storage device
22 storage identifier
23 plurality of storage devices
24 storage memory
26 storage controller
28 storage communication circuit
30 local communication channel
30A, 30B, 30C local wireless communication channel
30D local wired communication channel
32 communication network
34 remote communication network
40 computer
50 information, digital images
60 server
100 communication path
101 read identifier on storage device step
102 enter identifier with user interface step
103 send identifier to storage device step
110 communication path
111 camera receives identifier step
112 match identifier to storage device step
113 accept identifier with user interface step
120 communication path
121 enter identifier with user interface step
122 camera receive encrypted communication step
123 camera decrypt communication with identifier step
130 communication path
131 photograph identifier on storage device step
132 extract identifier from photo step
133 accept identifier with user interface step
200 set camera id# step
205 user recorded/selected image step
210 modified image step
215 check storage device setup status step
220 store image in user account step
225 instruct user to setup step
230 instruct user to move camera step
235 switch to “limited range” step
240 add storage device id to modified user image step
245 create user account step
250 present user account icon step
300 place camera on remote storage device step
305 storage device check camera identification step
310 receive and store camera information step
315 get associated storage device network location step
320 receive and transfer camera information step
325 store information in associated storage device step
330 done step

1. A distributed image acquisition and storage system and communication network, comprising:
a plurality of digital cameras that acquire images and transmit the digital images through a local communication channel;
a plurality of storage devices connected to the communication network that receive digital images from any of the plurality of digital cameras through the local communication channel, that store digital images, and that transmit and receive digital images over the communication network, each storage device located remotely from other storage device(s) so that each of the first and second storage devices has a separate local communication channel, and each storage device is associated with one or more of the plurality of digital cameras and not associated with other of the plurality of digital cameras; and wherein each storage device:
(a) stores digital images received from associated digital cameras;
(b) transmits digital images received from non-associated digital cameras through the communication network to the storage device that is associated with the digital camera from which the digital images are received; and
(c) receives digital images from associated digital camera(s) through the communication network from non-associated storage devices.

2. The distributed image acquisition and storage system of claim 1, wherein each of the storage devices provides a separate and distinct single logical storage structure.

3. A method of distributing and storing acquired images, comprising:
providing a distributed image acquisition and storage system according to claim 1;
providing an address for each storage device and including in each digital camera the address for the storage device associated with the digital camera;
acquiring a digital image with a digital camera;
transmitting the digital image and associated storage device address from the digital camera to a non-associated storage device;
transmitting the digital image from the non-associated storage device through the communication network to the storage device associated with the digital camera; and
storing the digital image in the storage device associated with the digital camera.

4. A method of distributing and storing acquired images, comprising:
providing a distributed image acquisition and storage system according to claim 1;
providing an address and an identifier for each storage device and including in each digital camera the identifier for the storage device associated with the digital camera;
providing a computer server connected to the remote communication network, the computer server having an association list including an association between the identifiers and the address for each storage device;
acquiring a digital image with a digital camera;
transmitting the digital image and associated storage device identifier from the digital camera to a non-associated storage device;
transmitting the digital image and associated storage device identifier from the non-associated storage device through the communication network to the computer server;
determining the address of the associated storage device with the received associated storage device identifier by employing the association list on the computer server;
transmitting the digital image from the computer server through the communication network to the storage device associated with the digital camera; and
storing the digital image in the storage device associated with the digital camera.

5. The distributed image acquisition and storage system of claim 1, wherein each of the storage devices is functionally identical.

6. A distributed image acquisition and storage system having a communication network, comprising:
first and second digital cameras that acquire digital images and transmit the digital images through a local communication channel;
first and second storage devices connected to the communication network that receive digital images from the first and second digital cameras through the local communication channel, that store the received digital images, and that transmit and receive digital images over the communication network, wherein the second storage device is remote from the first storage device so that each of the first and second storage devices has a separate local communication channel and each of the first and second digital cameras transmits and receives digital images directly through the separate local communication channel with one of the first and second storage devices at one time;
wherein the first storage device stores digital images received through the separate local communication channel from the first digital camera, transmits digital images received from the second digital camera through the separate local communication network to the second storage device through the communication network, and receives and stores digital images received from the second storage device through the remote communication network; and
wherein the second storage device stores digital images received through the separate local communication channel from the second digital camera, transmits digital images received from the first digital camera through the separate local network to the first storage device through the communication network, and receives and stores digital images received from the first storage device through the communication network.

7. The distributed image acquisition and storage system of claim 6, wherein the communication network is the internet, or the local communication channel is a wireless local area network, a wireless point-to-point communication channel, or the local communication channel is a dock interface between a storage device and a digital camera.

8. The distributed image acquisition and storage system of claim 6, wherein each of the first and second storage devices has a different unique communication network address identifier.

9. The distributed image acquisition and storage system of claim 8, wherein the unique communication network address identifier for each of the first and second storage devices is an internet protocol address.

10. The distributed image acquisition and storage system of claim 8, wherein each of the first and second digital cameras includes the unique communication network address identifier of one of the first or second storage devices and transmits the unique communication network address identifier with the digital images to the first or second storage device.

11. The distributed image acquisition and storage system of claim 6, further comprising additional digital cameras that acquire images and transmit and receive the digital images.

12. The distributed image acquisition and storage system of claim 11, further comprising additional storage devices storage devices connected to the communication network and that store digital images, receive digital images from the first, second, and additional digital cameras, and transmit and receive digital images from other storage devices.

13. The distributed image acquisition and storage system of claim 12, wherein each storage device is associated with one or more digital cameras; and
(a) stores digital images received directly from its associated digital camera;
(b) stores digital images received from its associated digital camera through the communication network from other storage devices; and
(c) transmits digital images received from non-associated digital cameras to the storage device that is associated with the digital camera from which the digital images are received.

14. The distributed image acquisition and storage system of claim 13, wherein the transmitted digital images are transmitted first to another storage device that is not associated with the digital camera from which the digital images are received and then to the storage device that is associated with the digital camera from which the digital images are received.

15. The distributed image acquisition and storage system of claim 6, wherein the first and second digital cameras receive stored digital images from the first and second storage devices.

16. The distributed image acquisition and storage system of claim 6, wherein the first and second digital cameras wirelessly transmit the digital images and wherein the first and second storage devices wirelessly receive digital images from the first and second digital cameras.

17. The distributed image acquisition and storage system of claim 16, wherein the first and second digital cameras wirelessly receive stored digital images.

18. The distributed image acquisition and storage system of claim 6, further including a server computer connected to the remote communication network that receives digital images from the first and second storage devices and transmits the received digital images to the second and first storage devices, respectively.

19. The distributed image acquisition and storage system of claim 18, further including a first identifier and first address associated with the first storage device and a second identifier and second address different from the first identifier and first address associated with the second storage device, and wherein the first digital camera transmits the first identifier with the transmitted digital images and the second digital camera transmits the second identifier with the transmitted digital images, and wherein the server computer includes an association list having the first identifier associated with the first address and the second identifier associated with the second address, and wherein the server receives one or more first digital images with the first identifier and transmits the first digital images to the first storage device at the first address and receives one or more second digital images with the second identifier and transmits the second digital images to the second storage device at the second address.

20. The distributed image acquisition and storage system of claim 6, wherein the first and second storage devices each provide a separate and distinct single logical storage structure.
